(19) United States
(12) Patent Application Publication
(10) Pub. No.: US 2011/0194473 A1
(43) Pub. Date: Aug. 11, 2011

(54) POWER-SAVING METHOD AND APPARATUS THEREOF

(75) Inventor: Kuo Cheng Lu, Hsinchu County (TW)

(73) Assignee: RALINK TECHNOLOGY CORPORATION, HSINCHU COUNTY (TW)

(21) Appl. No.: 13/006,084

(22) Filed: Jan. 13, 2011

(30) Foreign Application Priority Data
Feb. 6, 2010 (TW) 099103612

(51) Int. Cl. G08C 17/00

(52) U.S. Cl. 370/311

(57) ABSTRACT

The present invention discloses a power-saving method. The method comprises the steps of: forwarding a packet in accordance with a forwarding signal; operating in a power-saving receiving mode to enable a receiver in accordance with a receiving enable signal; and determining whether a standard receiving mode is operating in accordance with a packet detection result.

### BACKGROUND OF THE INVENTION

1. Field of the Invention

The present invention relates to a method and apparatus for receiving signals and, particularly, to a power-saving method and apparatus applied to an access point.

2. Description of the Related Art

In recent years, much research has been dedicated to reduction of power loss for stations in a wireless local area network (WLAN). These stations in a WLAN include notebooks or hand-held devices powered by a battery. In contrast, because the access points in WLAN are powered directly by AC power supply, researchers have spent comparatively little effort on this topic.

During normal operation, an access point periodically transmits beacon packets to a power-saving station or a non-associate station for synchronization. Prior to establishment of the link between the non-associate station and the access point, a hand-off procedure is needed to establish the communication. Generally, the hand-off procedure includes three phases: scanning, authentication and association. According to Institute of Electrical and Electronics Engineers (IEEE) 802.11 standards, in a scanning phase, the station must scan all existing channels. Nowadays, the scanning method includes both active mode and passive mode scanning. In an active mode, the station selects a channel and transmits a probe request packet first, and then waits for a specific period of time to receive a responding probe request packet. If such responding probe request packet is not received within the specific time, the station changes to a new channel and repeats the same procedure.

FIG. 1 shows a passive mode scanning method. During the operation of the passive mode, a station selects a channel and listens for a given period of time. If no beacon packet broadcasts are received within the period, then the station changes to a new channel and repeats the same procedure.

FIG. 2 shows an active mode scanning method. After the scanning procedure, the station has to proceed with authentication and association.

FIG. 3 shows a station which is executing procedures of authentication and association.

FIG. 4 shows a case where, when there is no association with any stations, the access point still enables the receiver to receive probe request packets from any station. If no operation is performed within a long period (e.g., during night hours), the standard receiving procedure is inefficient in view of power usage.

Therefore, it is necessary to propose a power-saving method to enable more efficient use of power and energy by access points.

### SUMMARY OF THE INVENTION

The present invention proposes a method for efficiently using power and energy.

The power-saving method in accordance with one embodiment of the present invention comprises the steps of: forwarding a packet in accordance with a forwarding signal; operating in a power-saving receiving mode for enabling a receiver in accordance with a receiving enable signal; and determining whether a standard receiving mode is entered in accordance with a packet detection result, wherein power loss during the operation of the power-saving receiving mode is used to determine whether there is any packet to be transmitted to the receiver to generate the packet detection result.

The power-saving apparatus in accordance with one embodiment of the present invention comprises a forwarding unit, a receiving unit, a mode-switching unit and a channel-switching unit. The forwarding unit is configured to forward a packet in accordance with a forwarding signal. The receiving unit is configured to operate in a power-saving receiving mode in accordance with an enable receiving signal to receive signals, wherein power loss during the operation of the power-saving receiving mode is used only to determine whether there is any packet to be transmitted to the receiver. The mode-switching unit is configured to control the receiving to unit to operate in the power-saving receiving mode or in a standard receiving mode, depending on whether a packet detecting result or an idle determining result occurs. The channel-switching unit is configured to select operating channels of the forwarding unit and receiving unit in accordance with a packet identification result.

The present power-saving method and the apparatus thereof select an operational mode between a power-saving receiving mode and a standard receiving mode based on a packet detecting result or an idle determining result. When operating in the power-saving receiving mode, the present invention uses a minimal power loss to determine whether any packets need to be transmitted to the access point, even if there is no need to acquire the contents of the packet, so that the purpose of saving power can be achieved. In addition to the function that uses a minimal power loss to determine whether any packet needs to be transmitted, when operating in the power saving receiving mode, the present invention also proposes a power saving method to periodically receive signals during the forwarding interval between two adjacent beacon packets.

### BRIEF DESCRIPTION OF THE DRAWINGS

The invention will be described according to the appended drawings in which:

FIG. 1 shows a passive mode scanning method;

FIG. 2 shows an active mode scanning method;

FIG. 3 shows a station which is executing procedures of authentication and association;

FIG. 4 shows a case where, when there is no association with any stations, the access point still enables the receiver to receive probe request packets from any station;

FIG. 5 shows a flow chart of a power-saving method for an access point in accordance with one embodiment of the present invention;

FIG. 6 shows a flow chart generating receiving enable signals;

FIG. 7A shows a periodic forwarding signal, which is a clock signal having high and low logic levels;

FIG. 7B shows a periodic power-saving receiving signal;

FIG. 8A shows an inverting signal of the periodic forwarding signal in FIG. 7A;

FIG. 8B shows an inverting signal of the periodic power-saving receiving signal in FIG. 7B;

FIG. 8C shows an enable receiving signal;

FIG. 9 shows the access point transmitting periodic beacon packet and operating in a power-saving mode according to the periodic forwarding signal and the enable receiving signal;

FIG. 10 shows the communication between an access point and a station;

FIG. 11 shows an access point which transmits periodic beacon packets and operates in a power-saving receiving mode;

FIG. 12 shows communication between the access point and the station; and

FIG. 13 shows a power-saving apparatus used in an access point.

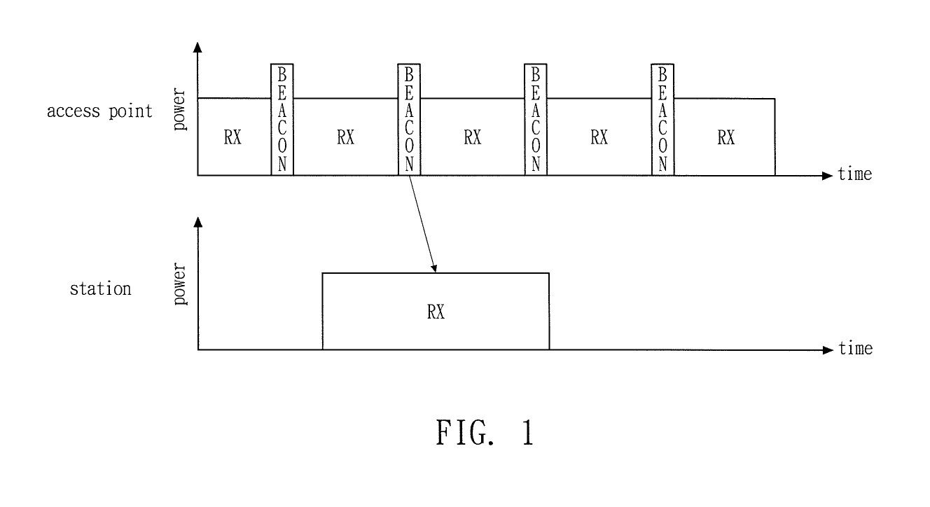

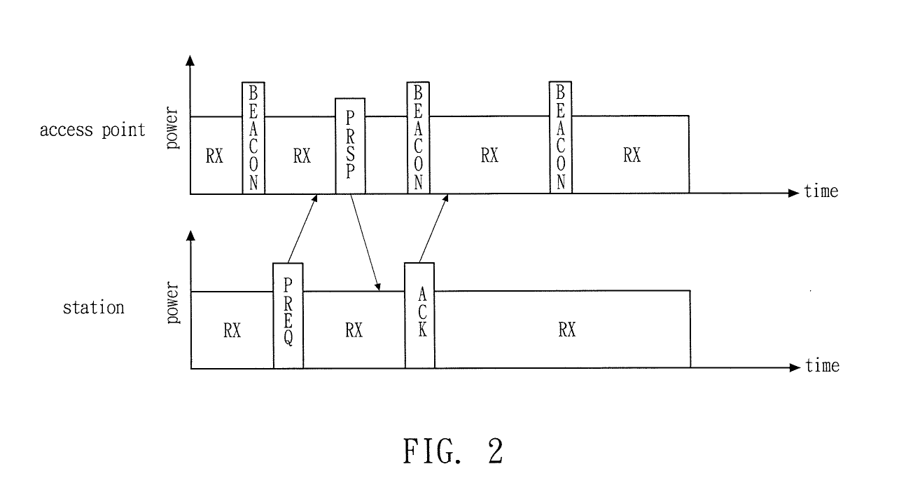

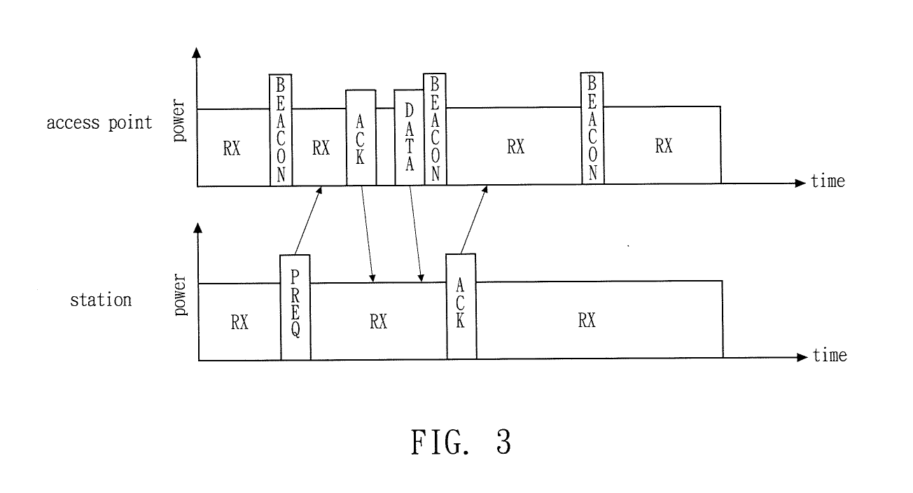

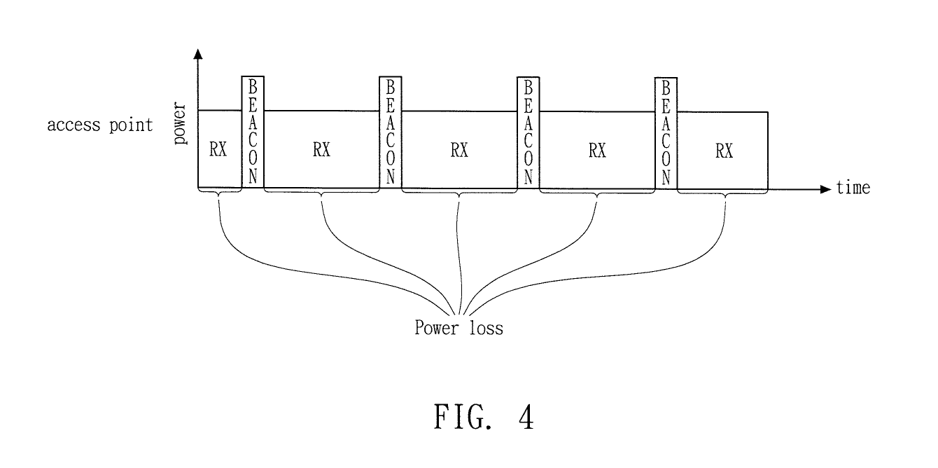

### PREFERRED EMBODIMENT OF THE PRESENT INVENTION

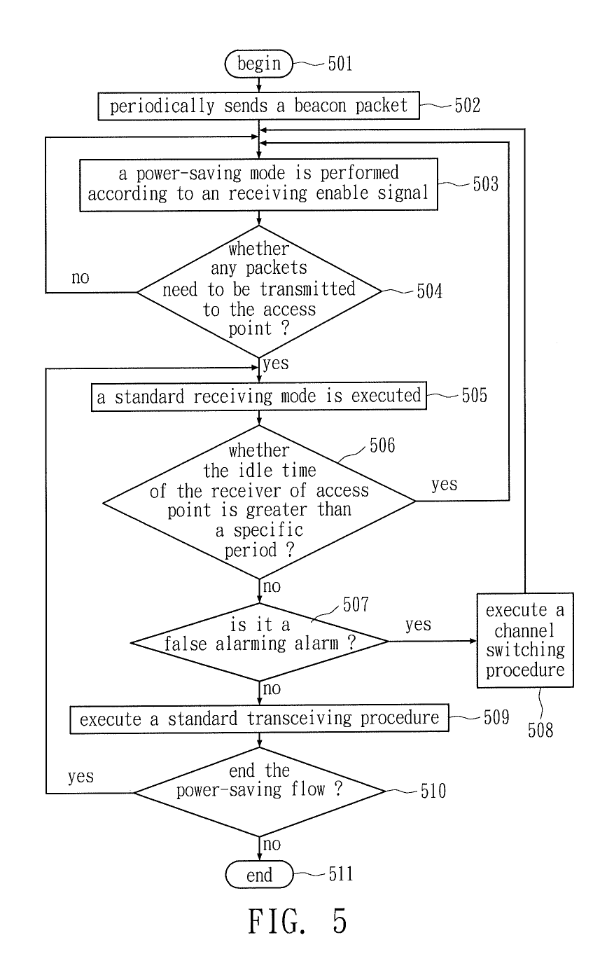

FIG. 5 shows a flow chart of a power-saving method for an access point in accordance with one embodiment of the present invention. In step 501, the flow begins. In step 502, the transmitter of the access point periodically sends a packet, such as a beacon packet, e.g., according to periodic forwarding signals. In step 503, a power-saving mode is entered according to an enable receiving signal so as to periodically enable the receiver of the access point.

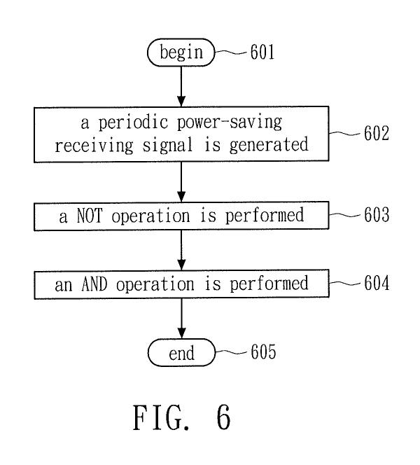

FIG. 6 shows a flow chart generating receiving enable signals. In step 601, the flow that generates receiving enable signals starts. In step 602, a periodic power-saving receiving signal is generated. In step 603, a NOT operation is performed according to the periodic forwarding signal to generate a corresponding inverting signal. In addition, a NOT operation is performed according to the periodic power-saving receiving signal to generate the corresponding inverting signal. In step 604, an AND operation is performed according to the inverting signals of the periodic forwarding signal and periodic power-saving receiving signal so as to generate the enable receiving signal. In step 605, the flow ends.

In step 504, during the operation of the power-saving receiving mode, it is determined whether there are any packets to be transmitted to the access point. According to one embodiment, the determination can be done by observing the received signal strength indication, but there are other methods of performing such determination. For example, if a received signal strength indication is greater than a threshold, a packet needs to be transmitted to the access point. In contrast, if a received signal strength indication is less than or equal to the threshold, then no packet needs to be transmitted to the access point. In the other words, during the operation of the power-saving receiving mode, the receiver of the access point uses the minimal power loss to determine whether any packet needs to be transmitted to the access point, even if there is no necessity to obtain the contents of the packets. In step 504, if no packet needs to be transmitted to the access point, then the flow goes back to step 503. However, if it is determined that any packet needs to be transmitted to the access point, a standard receiving mode is entered in step 505. In the standard receiving mode, if any packet needs to be transmitted to the access point, the receiver of the access point uses regular power loss to execute standard packet receiving and packet processing flows. In step 506, it is determined whether the idle time of the receiver of the access point is greater than a threshold. If affirmative, the flow goes back to step 503. If not, it is determined whether a received packet in the standard mode is a false alarming packet. According to one embodiment of the present invention, the source information of the packet can be used to determine a false alarming packet. The false alarming packet may be a beacon packet transmitted from another access point. If the packet is a false alarming packet, then in step 508 the access point executes a channel switching procedure to switch to another channel. For example, if the packet is a probe request packet transmitted from a station, in step 509 the access point executes a standard transceiving procedure to complete the standard transceiving process with the station. Finally, in step 510 it is determined whether to end the power-saving flow. If not, the flow goes to step 511 and ends.

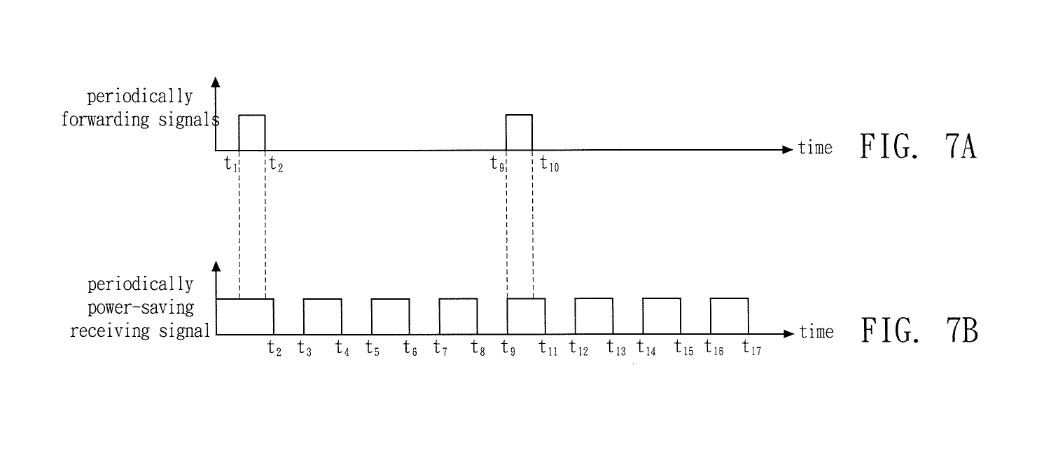

FIGS. 7 through 13 further describe the above flow. According to one embodiment, FIG. 7A shows a periodic forwarding signal, which is a clock signal having high and low logic levels. In step 502, the periodic beacon signals can be transmitted according to the periodic forwarding signal. According to one embodiment, FIG. 7B shows a periodic power-saving receiving signal generated in step 602.

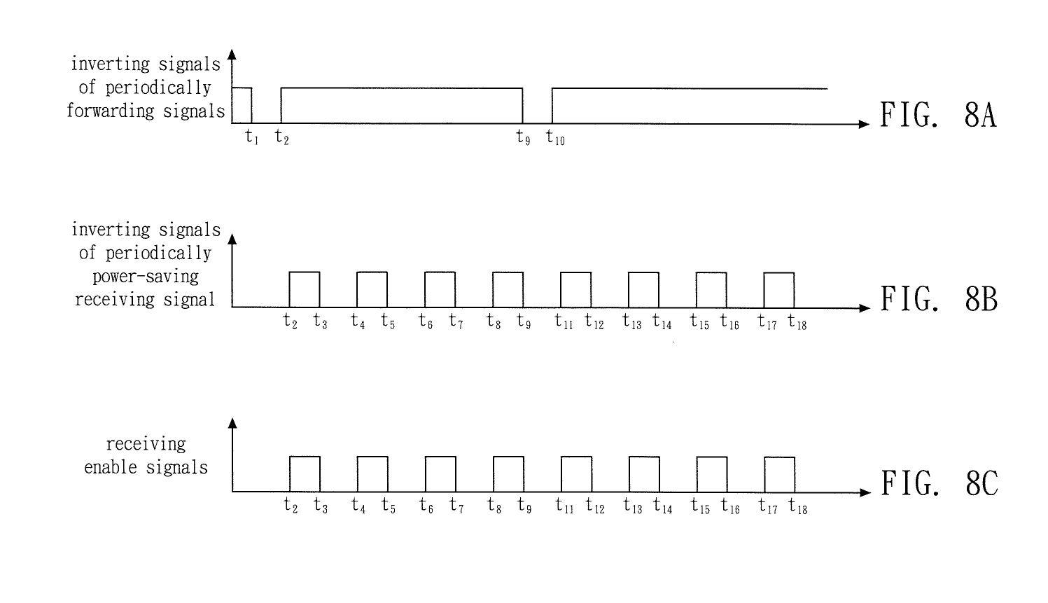

FIG. 8A shows an inverting signal of the periodic forwarding signal of FIG. 7A. FIG. 8B shows an inverting signal of periodic power-saving receiving signal in FIG. 7B. FIG. 8C shows an enable receiving signal generated in step 604.

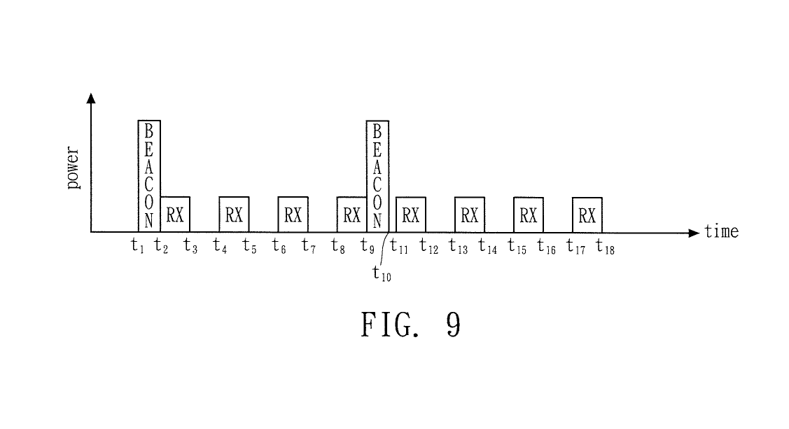

FIG. 9 shows the access point transmitting a periodic beacon packet and operating in a power-saving mode according to the periodic forwarding signal and the enable receiving signal.

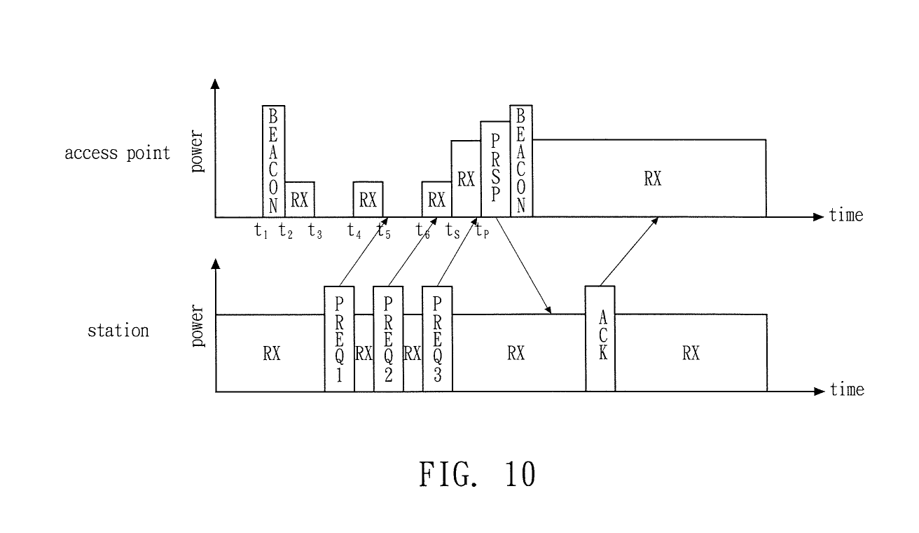

FIG. 10 shows the communication between an access point and a station. When the access point detects that the probe request packet 2 (PREQ2) needs to be transmitted to the access point, the access point immediately switches to a standard receiving mode. When the access point receives probe request packet 3 (PREQ3), the access point immediately switches to a standard transceiving mode. Accordingly, the access point operates a corresponding transceiving procedure in accordance with the content of the packets it receives, for example, in response to a probe response (PRSP) packet. Particularly, when operating in a power-saving receiving mode (e.g., during period t₂-t₃, t₄-t₅, or t₆-tₛ), the receiver of the access point uses the minimal power loss to determine whether any packets need to be transmitted to the access point, even if there is no need to acquire the contents of the packet. When operating in the standard receiving mode (e.g., during the period tₛ-tₚ), the receiver of the access point uses normal power loss to execute the standard packet receiving procedure.

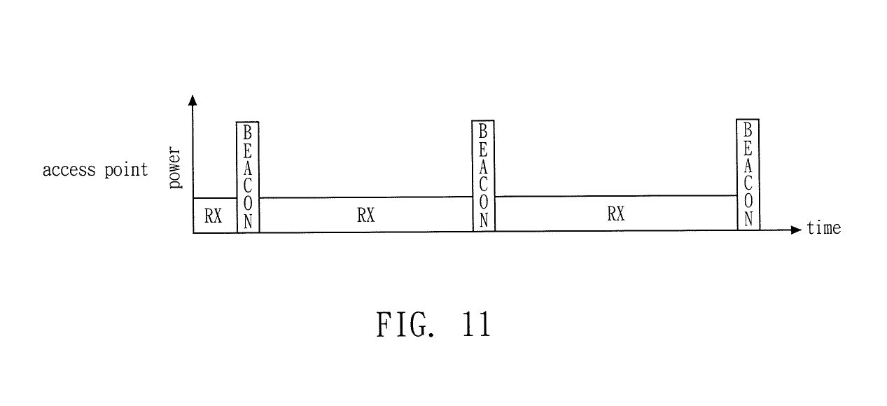

According to another embodiment, FIG. 11 shows an access point which transmits periodic beacon packets and operates in a power-saving receiving mode.

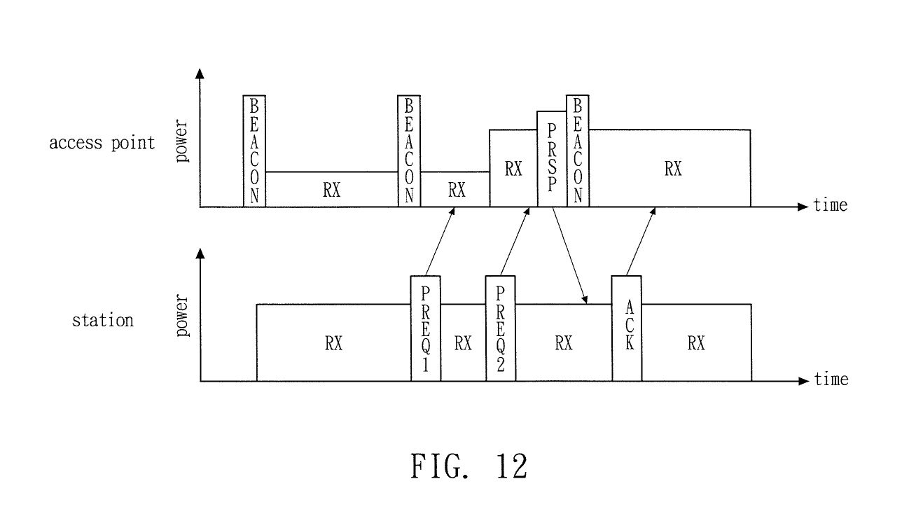

FIG. 12 shows communication between the access point and the station. When the access point detects that the probe request packet 1 (PREQ1) needs to be transmitted to the access point, the access point immediately switches to the standard receiving mode. When the access point detects that the probe request packet 2 (PREQ2) needs to be transmitted to the access point, the access point immediately switches to the standard transceiving mode.

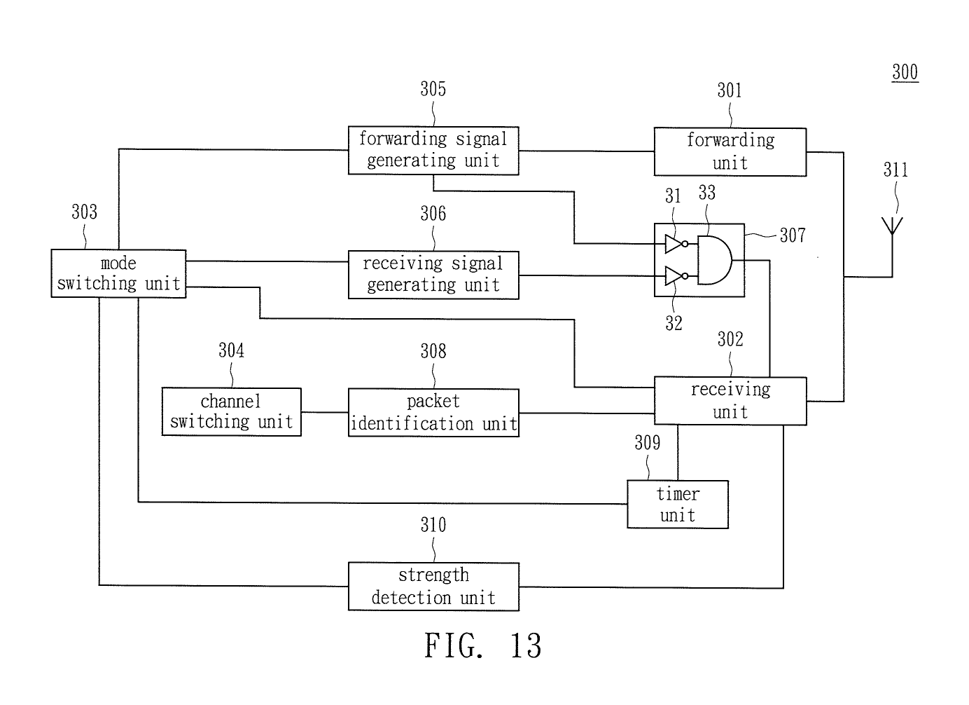

According to another embodiment of the present invention, FIG. 13 shows a power-saving apparatus 300 used in an access point. The power-saving apparatus 300 includes a forwarding unit 301, a receiving unit 302, a mode switching unit 303, a channel switching unit 304, a forwarding signal generating unit 305, a receiving signal generating unit 306, a logic operation unit 307, a packet identification unit 308, a timer unit 309, a strength detection unit 310 and an antenna 311. The forwarding unit 301 transmits a beacon packet in accordance with a periodic forwarding signal. The periodic signals may be clock signals having high logic level and low logic level as shown in FIG. 7A. The receiving unit 302 operates in a power saving receiving mode according to an enable receiving signal to periodically receive signals, wherein the power loss exhibited in the power receiving mode is only used to determine whether any packets need to be transmitted to the receiving unit. The receiving enable signals may be signals shown in FIG. 8C. The mode switching unit 303 controls the receiving unit 302 according to a packet detecting result or an idle determination result to operate in the power-saving receiving mode or a standard receiving mode. Particularly, when operating in the power-saving receiving mode, the receiving unit 302 uses the minimal power loss to determine whether any packets need to be transmitted to the access point, even if there is no need to acquire the contents of the packets. When operating in the standard receiving mode, the receiving unit 302 operates a standard packet receiving procedure with normal power loss. In addition, the power loss exhibited when the receiving unit operates in the power-saving mode is less than that exhibited in the standard receiving mode. The channel switching unit 304 selects operational channels of the forwarding unit 301 and the receiving unit 302 in accordance with a packet identification result. The forwarding signal generating unit 305 is used to generate the periodic forwarding signals. The receiving signal generating unit 306 is used to generate a periodic power-saving receiving signal, which may be a clock signal having high logic and low logic levels as shown in FIG. 7B. The logic operation unit 307 is used to generate the enable receiving signal in accordance with the periodic forwarding signal and the periodic power-saving receiving signal. The logic operation unit 307 includes, for example, inverting units 31, 32, and an AND operation unit 33. The packet identification unit 308 is used to identify the source information received by the receiving unit 302 to generate the packet identification result. The timer unit 309 is used to measure the idle time while the receiving unit 302 operates in the standard receiving mode so as to generate the idle determination result. When the receiving unit 302 operates in the power-saving receiving mode, the strength detecting unit 310 detects the received signal strength indication to generate the packet detecting result. According to one embodiment, the detecting method can be implemented by observing the received signal strength indication of the receiving unit 302. For example, if a received signal strength indication is greater than a threshold, a packet needs to be transmitted to the access point. In contrast, if a received signal strength indication is less than a threshold, no packet needs to be transmitted to the access point.

The present power-saving method and the apparatus thereof select an operational mode between a power-saving receiving mode and a standard receiving mode in accordance with a packet detecting result or an idle determining result. When operating in the power-saving receiving mode, the present invention uses a minimal power loss to determine whether any packets need to be transmitted to the access point, even if there is no need to acquire the contents of the packet, so that the purpose of saving power can be achieved. In addition to the function that uses a minimal power loss to determine whether any packet needs to be transmitted, when operating in the power saving receiving mode, the present invention also proposes a power saving method to periodically receive signals during the forwarding interval between two adjacent beacon packets.

The above-described embodiments of the present invention are intended to be illustrative only. Numerous alternative embodiments may be devised by persons skilled in the art without departing from the scope of the following claims.

What is claimed is:

1. A power-saving method, comprising the steps of:
forwarding a packet in accordance with a forwarding signal;
operating in a power-saving receiving mode for enabling a receiver in accordance with a receiving enable signal; and
determining whether a standard receiving mode is operating in accordance with a packet detection result;
wherein power loss during the operation of the power-saving receiving mode is used to determine whether there is any packet to be transmitted to the receiver to generate the packet detection result.

2. The method of claim 1, wherein the operation of the power-saving receiving mode is to periodically receive signals during a forwarding interval between two beacon packets.

3. The method of claim 1, further comprising determining whether to execute a channel-switching procedure in accordance with source information of a receiving packet.

4. The method of claim 1, further comprising switching from the standard receiving mode to the power-saving receiving mode during the operation of the standard receiving mode if an idle time exceeds a threshold.

5. The method of claim 1, further comprising the steps of:
generating a power-saving receiving signal; and
executing a logic operation procedure in accordance with the forwarding signal and power-saving receiving signal to generate the receiving enable signal.

6. The method of claim 5, wherein the logic operation procedure includes a NOT operation and an AND operation.

7. The method of claim 5, wherein the forwarding signal and power-saving receiving signal are of periodicity, and are clock signals having a high-logic level and a low-logic level.

8. The method of claim 1, wherein the determining step comprises the steps of:
operating in the power-saving receiving mode if a received signal strength indication is smaller than or equal to a threshold value; and
operating in the standard receiving mode if a received signal strength indication is greater than the threshold value.

9. The method of claim 1, wherein the power loss exhibited in the power-saving receiving mode is smaller than that exhibited in the standard receiving mode.

10. A power-saving apparatus, comprising:
a forwarding unit configured to forward a packet in accordance with a forwarding signal;
a receiving unit configured to operate in a power-saving receiving mode in accordance with an enable receiving signal to receive signals, wherein power loss during the operation of the power-saving receiving mode is used only to determine whether there is any packet to be transmitted to the receiver;
a mode-switching unit configured to control the receiving unit to operate in the power-saving receiving mode or a standard receiving mode in accordance with a packet detecting result or an idle determining result; and
a channel-switching unit configured to select operating channels of the forwarding unit and receiving unit in accordance with a packet identification result.

11. The power-saving apparatus of claim 10, further comprising:
a forwarding signal generating unit for generating the forwarding signal;
a receiving signal generating unit for generating a power-saving receiving signal; and
a logic operating unit configured to generate the enable receiving signal in accordance with the forwarding signal and power-saving receiving signal.

12. The power-saving apparatus of claim 10, further comprising a packet identification unit for identifying source information of received packets of the receiving unit to generate the packet identification result.

13. The power-saving apparatus of claim 10, further comprising a timer unit for measuring idle time of the receiving unit operating in the standard receiving mode to generate the idle determining result.

14. The power-saving apparatus of claim 10, further comprising a signal strength detecting unit for detecting receiving signal strength of the receiving unit to generate the packet detecting result.

15. The power-saving apparatus of claim 11, wherein the forwarding signal and power-saving receiving signal are of periodicity, and are clock signals having a high-logic level and a low-logic level.

16. The power-saving apparatus of claim 10, wherein the power loss exhibited in the power-saving receiving mode is smaller than that exhibited in the standard receiving mode.
